(19) United States
(12) Patent Application Publication
(10) Pub. No.: US 2026/0312329 A1
(43) Pub. Date: Oct. 8, 2026

(54) SPLIT MODULE FOR MODULAR CONNECTOR ASSEMBLY

(71) Applicant: Aptiv Technologies AG, Schaffhausen (CH)

(72) Inventors: Andreas URBANIAK, Münster (DE); Uvaraj GANESAN, Tamil Nadu (IN); Rajan KUMARESH, Tamil Nadu (IN)

(21) Appl. No.: 19/545,678

(22) Filed: Feb. 20, 2026

(30) Foreign Application Priority Data
Apr. 4, 2025 (EP) 25168574.9

(51) Int. Cl. H01R 13/514; H01R 43/18

(52) U.S. Cl. CPC H01R 13/514; H01R 43/18

(57) ABSTRACT

A modular connector assembly split module includes a module casing with at least one terminal cavity configured to accommodate an electrical terminal. The terminal cavity is formed along a longitudinal axis of the module casing. The module casing also includes a fastening element for securing the module casing to a second module casing of a complementary split module, thereby enabling the formation of a complete modular connector assembly.

### CROSS-REFERENCE TO RELATED APPLICATION

This application claims the benefit of and priority to European Application No. 25168574.9 filed with the European Patent Office on Apr 4, 2025, the contents of which are incorporated by reference herein.

### TECHNICAL FIELD

The present disclosure relates to a system and method for modular connector assemblies used in automotive applications. Specifically, the present disclosure relates to split modules that can be connected to form mixed modules, which can then be inserted into a connector housing to create a modular connector assembly. The disclosure also relates to a method for manufacturing a modular connector assembly.

### BACKGROUND

In the field of automotive electrical systems, it is common to use modular connector assemblies to facilitate the connection of various electrical components. These connectors are essential for ensuring reliable communication and power distribution throughout the vehicle. Known systems typically involve connector housings with multiple slots to accommodate different (monoblock) modules, each containing several terminal cavities for electrical terminals. However, these systems often face challenges related to flexibility and adaptability. For instance, the need to accommodate a wide range of terminal configurations and sizes can lead to increased complexity in the design and manufacturing process. Additionally, ensuring a secure and stable connection between modules within the connector housing can be problematic, especially when dealing with vibrations and other environmental factors common in automotive applications.

One of the general problems in automotive connection systems is the need for high-density connections in limited spaces. As vehicles become more technologically advanced, the number of electronic components and sensors increases, necessitating more connections within the same or even smaller spaces. This demand for miniaturization without compromising the reliability and performance of the connections poses significant design and engineering challenges. Moreover, the connectors must be robust enough to withstand harsh automotive environments, including extreme temperatures, moisture, and mechanical stress, which can affect the integrity and performance of the electrical connections over time.

Despite the substantial advances in the field of modular connector assemblies, there remains a need for improved systems that offer greater flexibility, ease of assembly, and reliability. Current solutions often lack the ability to easily customize and reconfigure the modules to meet specific application requirements. This limitation can result in increased production costs and longer development times, as manufacturers may need to design and produce multiple connector variants to accommodate different terminal configurations. Furthermore, ensuring a secure and stable connection between modules, while allowing for easy assembly and disassembly, remains a critical challenge that has not been fully addressed by existing technologies.

FIG. 1 illustrates a connector assembly 1, which is representative of prior art in the field of electrical connectors. This assembly houses a module with a monoblock structure, meaning it is constructed as a single, unified piece rather than including multiple detachable components. The assembly integrates terminal cavities 2 of various types, allowing for the accommodation of different electrical terminals within a singular housing 3.

The modular connector assembly 1 is depicted with a housing 3 that encapsulates the terminal cavities 2. The housing 3 serves as the structural framework that holds the terminal cavities 2 in place and provides protection against environmental factors such as dust and moisture. The housing is typically made from a durable material, often a type of plastic or composite, which ensures the integrity and longevity of the connector assembly in various applications, including automotive and industrial environments.

The terminal cavities 2 within the housing 3 are arranged in a grid-like pattern, allowing for the efficient organization and connection of multiple electrical terminals. These cavities are designed to securely hold the terminals in place, ensuring reliable electrical connections. The configuration of the terminal cavities can vary, accommodating assorted sizes and types of terminals, which is essential for the versatility of the modular connector assembly in interfacing with various electrical systems.

The module’s monoblock structure may limit the flexibility of the connector assembly 1 in terms of customization and scalability, as the entire module must be replaced or modified if changes to the connector assembly 1 configuration are required.

It is therefore a technical problem underlying the present invention to provide a modular connector assembly that at least partially overcomes the disadvantages of known systems.

### SUMMARY

The present disclosure relates to modular connector assemblies, particularly for automotive applications.

In one aspect, a split module for a modular connector assembly is provided. The split module includes a module casing and at least one terminal cavity configured to accommodate an electrical terminal, the at least one terminal cavity being formed along a longitudinal axis of the module casing. The module casing further includes at least one fastening element configured to mechanically connect the module casing to a module casing of another split module.

In some embodiments, the fastening element includes a slide or a rail extending along a guiding axis. The guiding axis may be oriented perpendicular or parallel to the longitudinal axis of the module casing. The fastening element may have a dovetail shape, an L-shape, or a T-shape. In some embodiments, the fastening element includes at least one snap hook and/or at least one locking shoulder configured to cooperate with a complementary fastening element of another split module.

In some embodiments, the split module includes between one and twenty terminal cavities. The terminal cavities may be arranged in one or two rows. A pitch distance between adjacent terminal cavities may be between 0.1 mm and 5 mm.

In another aspect, a mixed module is provided. The mixed module includes at least a first split module and a second split module according to the present disclosure, the first and second split modules being mechanically connected to each other by their respective fastening elements. In some embodiments, the fastening elements are configured to prevent relative movement of the split modules along the longitudinal axis by a form-fit connection. The split modules together may include a total number of terminal cavities between two and forty, and the split modules may include the same or different numbers of terminal cavities.

In a further aspect, a modular connector assembly for automotive applications is provided. The modular connector assembly includes a connector housing having at least one module slot, the at least one module slot being configured to accommodate a mixed module according to the present disclosure. The connector housing may include multiple module slots. In some embodiments, a module slot has a length between 20 mm and 30 mm and a height between 5 mm and 10 mm.

In another aspect, a method for manufacturing a modular connector assembly is provided. The method includes forming a mixed module by mechanically connecting a first split module and a second split module and inserting the mixed module into a module slot of a connector housing along the longitudinal axis of the split modules.

### BRIEF DESCRIPTION OF THE DRAWINGS

Other features, details, and advantages of the disclosure will become more apparent from the detailed illustrative description given hereafter with respect to the drawings in which:

FIG. 1 shows an end view of a connector assembly according to the prior art.

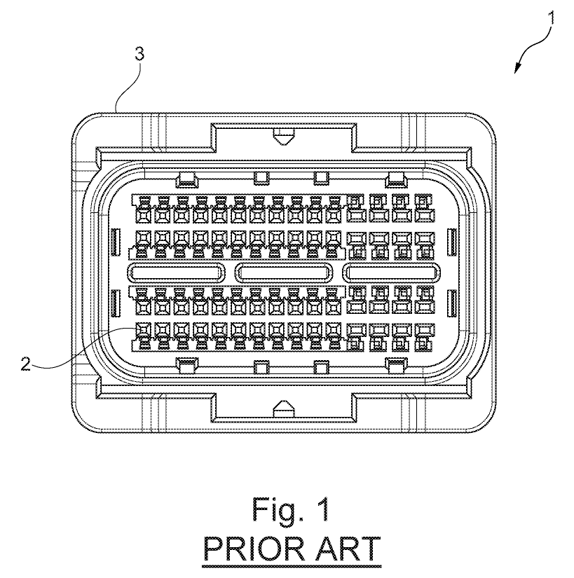

FIGS. 2A and 2B illustrate combinations of split modules to form mixed modules according to some embodiments.

FIGS. 3A to 3D shows a process of forming a mixed module by connecting a first split module and a second split module according to some embodiments.

FIG. 4 shows an isometric view of a split module according to some embodiments.

FIGS. 5A and 5B show isometric views of a modular connector assembly according to some embodiments.

### DETAILED DESCRIPTION

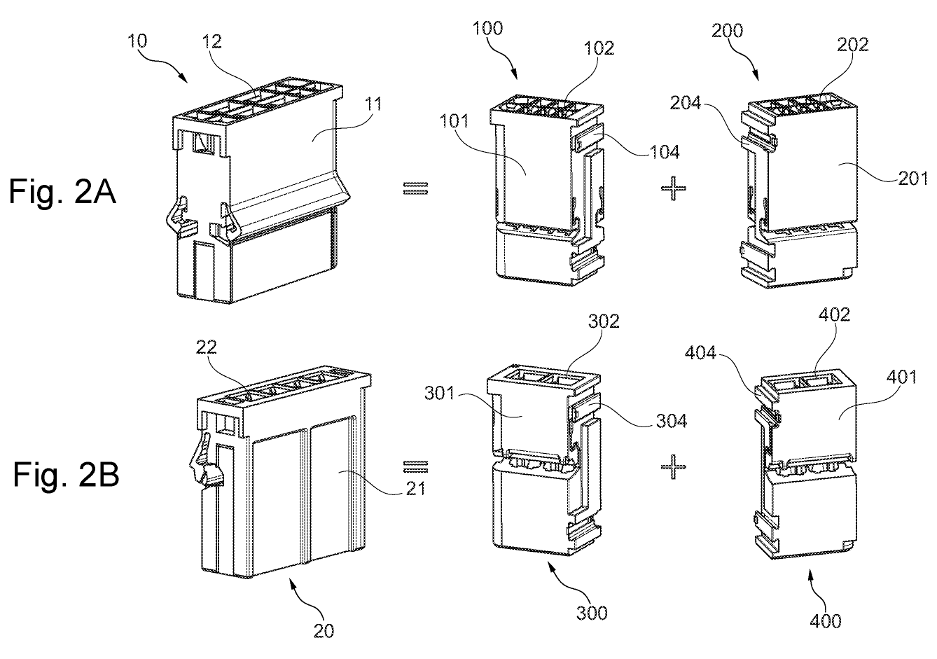

FIGS. 2A and 2B illustrate the possible replacement of prior art modules 10 and 20 with split modules 100, 200, 300, 400 that can be combined to form mixed modules. FIGS. 2A and 2B show two examples of this replacement.

In FIG. 2A, module 10, which is a known module from the prior art, is depicted. Module 10 includes a module casing 11 and terminal cavities 12 that are arranged in two rows. This module 10 can be replaced by combining two split modules, specifically split module 100 and split module 200. Split module 100 includes a module casing 101 and terminal cavities 102 that are arranged in two rows. It also includes a fastening element 104 for connecting to another split module. Split module 200 includes a module casing 201, terminal cavities 202 that are arranged in one row, and a fastening element 204. When split module 100 and split module 200 are connected via their respective fastening elements 104 and 204, they form a mixed module that can replace the prior art module 10.

In FIG. 2B, module 20, another known module from the prior art, is depicted. Module 20 includes a module casing 21 and terminal cavities 22. This module 20 can be replaced by combining two split modules, specifically split module 300 and split module 400. Split module 300 includes a module casing 301 and terminal cavities 302. It also includes a fastening element 304 for connecting to another split module. Split module 400 includes a module casing 401, terminal cavities 402, and a fastening element 404. When split module 300 and split module 400 are connected via their respective fastening elements 304 and 404, they form a mixed module that can replace the prior art module 20.

FIGS. 2A and 2B demonstrate the modularity and flexibility of the split modules, allowing for the creation of mixed modules that can replace existing standard modules in a modular connector assembly. This approach provides the advantage of customizable configurations, enabling the assembly to accommodate various electrical terminal requirements by combining different split modules. The fastening elements ensure a secure connection between the split modules, maintaining the structural integrity and functionality of the mixed module.

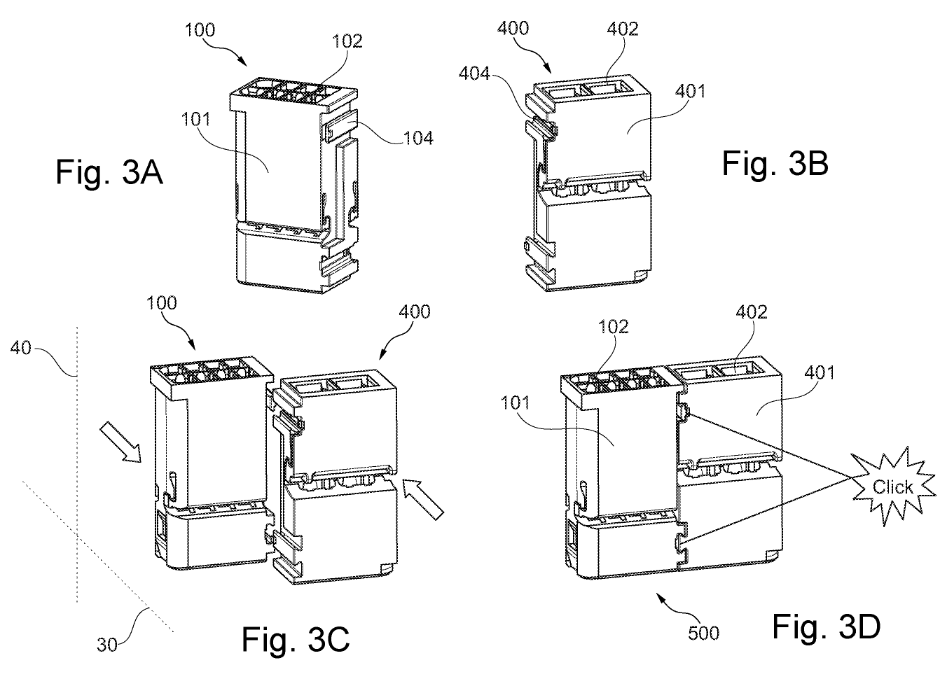

FIGS. 3A-3D illustrate the assembly process of a mixed module 500, which includes a first split module 100 and a second split module 400. FIGS. 3A-3D provide a visual representation of the components and their interaction during the assembly process.

The terminal cavities 102 are designed to accommodate electrical terminals and are aligned along the longitudinal axis 40 of the module casing 101. The module casing 101 is equipped with a fastening element 104, which is integral to the process of connecting the first split module 100 to the second split module 400.

The second split module 400 is similarly structured. This module also includes a fastening element 404, which is designed to engage with the fastening element 104 of the first split module 100. The fastening elements 104 and 404 are crucial for the secure attachment of the two modules, ensuring a stable and reliable connection. Fastening element 104 is a dovetail rail, while fastening element 404 is a dovetail slide.

The assembly process is depicted in a sequence of steps. Initially, the first split module 100 and the second split module 400 are positioned such that their respective fastening elements 104 and 404 are aligned as shown in FIGS. 3A and 3B. The guiding axis 30, which is perpendicular to the longitudinal axis 40, facilitates the alignment and connection of the modules. The modules are then brought together along the guiding axis 30, as indicated by the directional arrows in FIG. 3C.

Upon successful alignment and engagement of the fastening elements 104 and 404, the modules are securely connected, forming the mixed module 500 as shown in FIG. 3D. FIG. 3D indicates this successful connection with a “click” sound effect, symbolizing the completion of the assembly process. The mixed module 500 then includes the combined terminal cavities 102 and 402, allowing for a versatile configuration of electrical terminals.

The design of the fastening elements 104 and 404 is such that they prevent relative movement of the split modules 100 and 400 along the longitudinal axis 40, ensuring a form fit. This secure connection is essential for maintaining the integrity and functionality of the mixed module 500 in various applications.

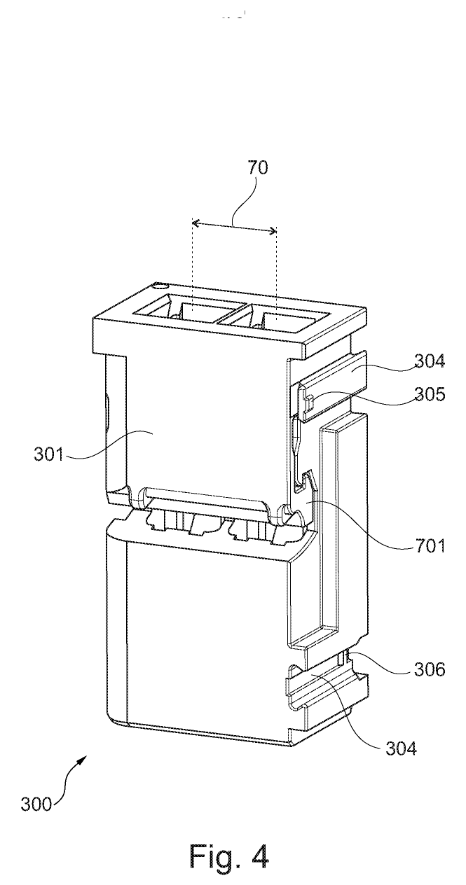

FIG. 4 illustrates an embodiment of a split module 300 for a modular connector assembly. The split module 300 includes a module casing 301 and terminal cavities 302 formed along a longitudinal axis 40 of the module casing 301. The module casing 301 includes fastening elements 304 at the top and at the bottom that are designed to fasten the module casing 301 to a second module casing of a second split module.

The fastening elements 304 in this embodiment are shown as a dovetail rail (at the top) and a dovetail slide (at the bottom) that extend along the guiding axis 30. The guiding axis 30 is perpendicular to the longitudinal axis 40 of the module casing 301, as depicted in FIG. 3C. The fastening element 304 at the top further includes a snap hook 305 and the fastening element 304 at the bottom a locking shoulder 306, which facilitate the secure attachment of the module casing 301 to the second module casing.

The split module 300 also features a terminal position assurance (TPA) 701, which ensures the proper positioning of the electrical terminals within the terminal cavities 302. The TPA 701 is an essential component for maintaining the reliability and integrity of the electrical connections within the split module 300.

The terminal cavities 302 are arranged with a specific pitch distance 70 between them, which can range from 0.1 mm to 5 mm. This pitch distance is crucial for accommodating various electrical terminals and ensuring proper alignment and spacing within the module casing 301.

The embodiment depicted in FIG. 4 shows a split module 300 that can be easily connected to another split module using the fastening elements 304, snap hook 305, and locking shoulder 306. This modular design allows for flexibility in configuring the connector assembly to meet specific requirements, such as the number of terminal cavities and the pitch distance between them.

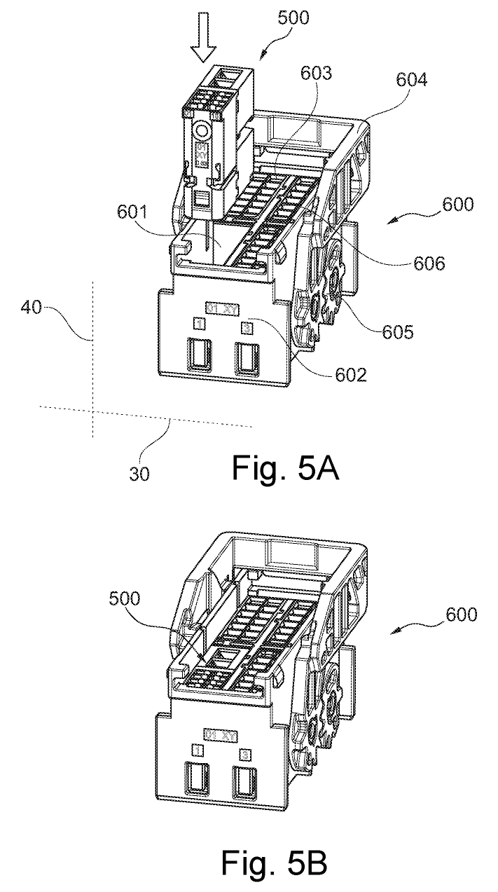

FIGS. 5A and 5B illustrate a modular connector assembly 600, which is designed for automotive applications. The assembly includes a connector housing 602 and is shown with a mixed module 500 being inserted into one of the module slots 601. The connector housing 602 is structured to accommodate multiple module slots, with the depicted embodiment featuring four module slots 601. These module slots are configured to house both mixed modules 500, as described in the invention, and standard monoblock modules 603, demonstrating the assembly's versatility in accommodating different module types.

The mixed module 500, which is composed of split modules, is inserted along the longitudinal axis 40 of the module slots 601. The design ensures that once fully inserted, the split modules forming the mixed module 500 are securely held in place. This is achieved because the connector housing 602 prevents any relative movement of the split modules along the guiding axis 30, thereby ensuring a stable connection.

The split modules forming the mixed module 500 have a different number of terminal cavities, highlighting the modularity of the modular connector assembly 600.

FIG. 5A also highlights the presence of a standard monoblock module 603 within the assembly, indicating that the modular connector assembly 600 is capable of housing both the inventive mixed modules and conventional monoblock modules simultaneously. This capability underscores the flexibility and configurability of the assembly in various applications, allowing for a combination of different module types to meet specific electrical or mechanical requirements.

The assembly is equipped with a mate assist lever 604, which interacts with mate assist means 605. This interaction facilitates an easier connection of the modular connector assembly 600 to counterpart connections, enhancing the user experience by simplifying the process of establishing a secure connection. The mate assist lever 604 is strategically positioned to provide leverage, thereby reducing the effort required during the mating process.

Additionally, the module slots 601 feature a coding groove 606. This groove is designed to interact with a coding rib on a module casing, ensuring the correct insertion of the module into the slot. The coding groove 606 serves as a guide, preventing incorrect orientation and insertion of the modules, which could otherwise lead to connection errors or damage to the assembly. In the depicted example, the mixed module 500 does not provide a coding rib for interaction with the coding groove, however, this in another embodiment one of the split modules forming the mixed module 500 may include a coding rib on the module casing.

FIGS. 3A-3D and FIGS. 5A and 5B together show a method of manufacturing the modular connector assembly 600. According to FIGS. 3A-3D, two split modules 100 and 400 are connected to form a mixed module 500. According to FIGS. 5A and 5B, the mixed module 500 then is inserted into the module slot 601 of the connector housing 602 along the longitudinal axis 40. The longitudinal axis 40 in FIG. 5A is the same as the longitudinal axis 40 in FIG. 3C, i.e., the longitudinal axis 40 of the split modules 100 and 400 of the split module 500.

While the invention has been described with reference to an exemplary embodiment(s), it may be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It may also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It may also be understood that the term “and/or” as used herein refers to and encompasses any and all possible combinations of one or more of the associated listed items. It may be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A split module for a modular connector assembly, comprising:
a module casing; and
at least one terminal cavity that is configured to accommodate an electrical terminal extending along a longitudinal axis of the module casing;
wherein the module casing comprises a fastening element for fastening the module casing to a second module casing of a second split module.

2. The split module of claim 1, wherein the module casing comprises a plurality of the fastening element.

3. The split module of claim 1, wherein the fastening element is a slide or rail that extends along a guiding axis.

4. The split module of claim 3, wherein the fastening element has a dovetail shape, an L-shape, or a T-shape.

5. The split module of claim 3, wherein a guiding axis defined by the fastening element is perpendicular or parallel to the longitudinal axis of the module casing.

6. The split module of claim 1, wherein the fastening element comprises a snap hook.

7. The split module of claim 1, wherein the fastening element comprises a locking shoulder.

8. The split module of claim 1, wherein the split module comprises between 1 and 20 terminal cavities.

9. The split module of claim 1, wherein a pitch distance between two terminal cavities is between 0.1 mm and 5 mm.

10. A mixed module comprising at least a first split module and a second split module according to claim 1, wherein the first and second split modules are connected to each other by means of their fastening element.

11. The mixed module of claim 10, wherein the fastening element prevents a relative movement of the split modules to each other along the longitudinal axis by means of a form fit between complementary rail and slide profiles.

12. The mixed module of claim 10, wherein the split modules together comprise a total number of terminal cavities between 2 to 40.

13. The mixed module of claim 10, wherein a total number of terminal cavities of the first split module is same or different from a total number of terminal cavities of the second split module.

14. A modular connector assembly for automotive applications, comprising:
a connector housing with at least one module slot; and
the mixed module according to claim 10, wherein the mixed module is accommodated by the at least one module slot.

15. The modular connector assembly of claim 14, wherein the connector housing comprises multiple module slots.

16. The modular connector assembly of claim 14, wherein the at least one module slot has a length of between 20 mm to 30 mm and a height of between 5 mm to 10 mm.

17. The modular connector assembly of claim 14, further comprising a plurality of mixed modules, each accommodated in a module slot of the connector housing, and each comprising a different total number of terminal cavities.

18. A method for manufacturing a modular connector assembly, comprising:
forming a mixed module by connecting a first split module and a second split module; and
inserting the mixed module into a module slot of a connector housing along a longitudinal axis of the split modules of the mixed module.
